(19) United States
(12) Patent Application Publication
(10) Pub. No.: US 2023/0262672 A1
(43) Pub. Date: Aug. 17, 2023

(54) METHOD OF WIRELESS COMMUNICATION, BASE STATION AND USER EQUIPMENT

(71) Applicant: OROPE FRANCE SARL, Neuilly-sur-Seine (FR)

(72) Inventor: Hao LIN, Neuilly-sur-Seine (FR)

(21) Appl. No.: 18/134,926

(22) Filed: Apr. 14, 2023

Related U.S. Application Data
(63) Continuation of application No. PCT/IB2020/000873, filed on Oct. 14, 2020.

(51) Int. Cl. H04W 72/0453; H04W 72/23

(52) U.S. Cl. CPC H04W 72/0453; H04W 72/23

(57) ABSTRACT

A method of wireless communication, a base station and user equipment are provided. The method by a user equipment (UE) includes being configured, by a base station, with a first frequency band and/or a second frequency band for a serving cell and performing transmission and/or reception in the first frequency band and/or the second frequency band.

### CROSS-REFERENCE TO RELATED APPLICATION

This is a continuation application of International Patent Application No. PCT/IB2020/000873, filed on Oct. 14, 2020, the disclosure of which is hereby incorporated by reference in its entirety.

### BACKGROUND OF DISCLOSURE

The present disclosure relates to the field of communication systems, and more particularly, to an apparatus and a method of wireless communication, which can provide a good communication performance and/or high reliability.

Non-terrestrial networks (NTNs) refer to networks, or segments of networks, using a spaceborne vehicle or an airborne vehicle for transmission. Spaceborne vehicles include satellites including low earth orbiting (LEO) satellites, medium earth orbiting (MEO) satellites, geostationary earth orbiting (GEO) satellites, and highly elliptical orbiting (HEO) satellites. Airborne vehicles include high altitude platforms (HAPs) encompassing unmanned aircraft systems (UAS) including lighter than air (LTA) unmanned aerial systems (UAS) and heavier than air (HTA) UAS, all operating in altitudes typically between 8 and 50 km, quasi-stationary.

Communication via a satellite is an interesting means thanks to its well-known coverage, which can bring the coverage to locations that normally cellular operators are not willing to deploy either due to non-stable crowd potential client, e.g. extreme rural, or due to high deployment cost, e.g. middle of ocean or mountain peak. Nowadays, the satellite communication is a separate technology to a 3rd generation partnership project (3GPP) cellular technology. Coming to 5G era, these two technologies can merge together, i.e. we can imagine having a 5G terminal that can access to a cellular network and a satellite network. The NTN can be good candidate technology for this purpose. It is to be designed based on 3GPP new radio (NR) with necessary enhancement.

In NTN, due to very high satellite altitude, a round trip time (RTT) between a sender (satellite/user equipment (UE)) and a receiver (UE/satellite) is extremely long. The communications shall need to take this long RTT into account for data transmission. Further, in NTN, due to the very long round trip time between the satellite and the user equipment, the transmission throughput is limited. Further, a moving base station or satellite, e.g. in particular for LEO satellite or drone, communicates with a user equipment (UE) on the ground. Due to long distance between the UE and the base station on satellite, the beamformed transmission is needed to extend the coverage. In a legacy terrestrial system, there is no configuration for beam separation in frequency domain.

Communication over unlicensed spectrum: In an unlicensed band, an unlicensed spectrum is a shared spectrum. Communication equipments in different communication systems can use the unlicensed spectrum as long as the unlicensed meets regulatory requirements set by countries or regions on a spectrum. There is no need to apply for a proprietary spectrum authorization from a government.

In order to allow various communication systems that use the unlicensed spectrum for wireless communication to coexist friendly in the spectrum, some countries or regions specify regulatory requirements that must be met to use the unlicensed spectrum. For example, a communication device follows a listen before talk (LBT) procedure, that is, the communication device needs to perform a channel sensing before transmitting a signal on a channel. When an LBT outcome illustrates that the channel is idle, the communication device can perform signal transmission; otherwise, the communication device cannot perform signal transmission. In order to ensure fairness, once a communication device successfully occupies the channel, a transmission duration cannot exceed a maximum channel occupancy time (MCOT).

On an unlicensed carrier, for a channel occupation time obtained by a base station, it may share the channel occupation time to a user equipment (UE) for transmitting an uplink signal or an uplink channel. In other words, when the base station shares its own channel occupancy time with the UE, the UE can use an LBT mode with higher priority than that used by the UE itself to obtain the channel, thereby obtaining the channel with greater probability. LBT is also called channel access procedure. UE performs channel access procedure before the transmission, if the channel access procedure is successful, i.e. the channel is sensed to be idle, the UE starts to perform the transmission. If the channel access procedure is not successful, i.e. the channel is sensed to be not idle, the UE cannot perform the transmission.

In the latest new radio unlicensed (NRU) system, if the NRU system is configured to be semi-static channel access mode, the UE cannot initiate a channel occupancy time (MCOT), and the UE has to detect a downlink signal before being allowed to transmit any uplink transmission. This will greatly limit a UE performance, and notably increasing transmission latency. To envision any latency stringent service, e.g. factory machine type communications or high quality surveillance, the latency needs to be reduced.

A UE performs communications with a network or a base station in cellular system will involve network configuring radio resource control (RRC) parameters to the UE according to timing varying radio environment or UE capability of supporting a set of features.

Therefore, there is a need for an apparatus (such as a user equipment (UE) and/or a base station) and a method of wireless communication, which can solve issues in the prior art, reduce inter-beam interference, realize frequency division multiplexed (FDM) beams, provide a good communication performance, and/or provide high reliability.

### SUMMARY

An object of the present disclosure is to propose an apparatus (such as a user equipment (UE) and/or a base station) and a method of wireless communication, which can solve issues in the prior art, reduce inter-beam interference, realize frequency division multiplexed (FDM) beams, provide a good communication performance, and/or provide high reliability.

In a first aspect of the present disclosure, a method of wireless communication by a user equipment (UE), comprising being configured, by a base station, with a first frequency band and/or a second frequency band for a serving cell and performing transmission and/or reception in the first frequency band and/or the second frequency band.

In a second aspect of the present disclosure, a method of wireless communication by a base station comprising configuring, to a user equipment (UE), a first frequency band and/or a second frequency band for a serving cell and performing transmission and/or reception in the first frequency band and/or the second frequency band.

In a third aspect of the present disclosure, a user equipment of processing a radio resource control (RRC) procedure delay comprises a memory, a transceiver, and a processor coupled to the memory and the transceiver. The processor is configured to be configured, by a base station, with a first frequency band and/or a second frequency band for a serving cell and the processor is configured to perform transmission and/or reception in the first frequency band and/or the second frequency band.

In a fourth aspect of the present disclosure, a base station of processing a radio resource control (RRC) procedure delay comprises a memory, a transceiver, and a processor coupled to the memory and the transceiver. The processor is configured to configure, to a user equipment (UE), a first frequency band and/or a second frequency band for a serving cell and the processor is configured to perform transmission and/or reception in the first frequency band and/or the second frequency band.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1A is a block diagram of one or more user equipments (UEs) and a base station (e.g., gNB) of communication in a communication network system (e.g., non-terrestrial network (NTN) or a terrestrial network) according to an embodiment of the present disclosure.

FIG. 1B is a block diagram of one or more user equipments (UEs) and a base station (e.g., gNB) of communication in a non-terrestrial network (NTN) according to an embodiment of the present disclosure.

FIG. 2 is a flowchart illustrating a method of processing a radio resource control (RRC) procedure performed by a user equipment (UE) according to an embodiment of the present disclosure.

FIG. 3 is a flowchart illustrating a method of processing a radio resource control (RRC) procedure performed by a base station according to an embodiment of the present disclosure.

FIG. 4 is a schematic diagram illustrating a communication system including a base station (BS) and a UE according to an embodiment of the present disclosure.

FIG. 5 is a schematic diagram illustrating that a BS transmits 3 beams to the ground forming 3 footprints according to an embodiment of the present disclosure.

FIG. 6 is a schematic diagram illustrating a beam related configuration for a NTN system according to an embodiment of the present disclosure.

FIG. 7 is a schematic diagram illustrating a beam related configuration for a NTN system according to an embodiment of the present disclosure.

FIG. 8 is a schematic diagram illustrating a beam related configuration for a NTN system according to an embodiment of the present disclosure.

FIG. 9 is a schematic diagram illustrating a beam related configuration for a NTN system according to an embodiment of the present disclosure.

FIG. 10 is a schematic diagram illustrating a beam related configuration for a NTN system according to an embodiment of the present disclosure.

FIG. 11 is a schematic diagram illustrating a beam related configuration for a NTN system according to an embodiment of the present disclosure.

FIG. 12 is a schematic diagram illustrating a beam related configuration for a NTN system according to an embodiment of the present disclosure.

FIG. 13 is a schematic diagram illustrating a beam related configuration for a NTN system according to an embodiment of the present disclosure.

FIG. 14 is a schematic diagram illustrating a beam related configuration for a NTN system according to an embodiment of the present disclosure.

FIG. 15 is a schematic diagram illustrating a beam related configuration for a NTN system according to an embodiment of the present disclosure.

FIG. 16 is a schematic diagram illustrating a beam related configuration for a NTN system according to an embodiment of the present disclosure.

FIG. 17 is a schematic diagram illustrating a beam related configuration for a NTN system according to an embodiment of the present disclosure.

FIG. 18 is a schematic diagram illustrating a beam related configuration for a NTN system according to an embodiment of the present disclosure.

FIG. 19 is a schematic diagram illustrating a beam related configuration for a NTN system according to an embodiment of the present disclosure.

FIG. 20 is a schematic diagram illustrating a beam related configuration for a NTN system according to an embodiment of the present disclosure.

FIG. 21 is a schematic diagram illustrating a beam related configuration for a NTN system according to an embodiment of the present disclosure.

FIG. 22 is a schematic diagram illustrating a beam related configuration for a NTN system according to an embodiment of the present disclosure.

FIG. 23 is a schematic diagram illustrating a beam related configuration for a NTN system according to an embodiment of the present disclosure.

FIG. 24 is a schematic diagram illustrating a beam related configuration for a NTN system according to an embodiment of the present disclosure.

FIG. 25 is a schematic diagram illustrating a beam related configuration for a NTN system according to an embodiment of the present disclosure.

FIG. 26 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

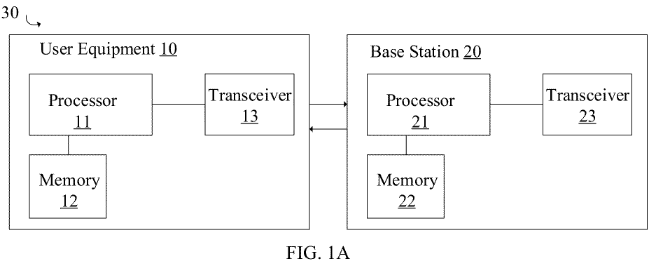

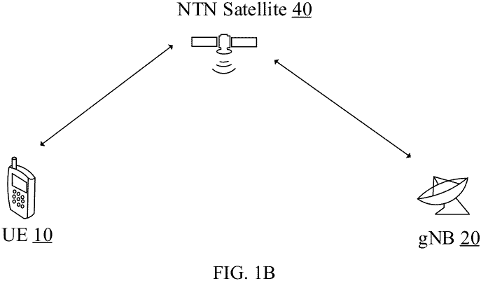

FIG. 1A illustrates that, in some embodiments, one or more user equipments (UEs) 10 and a base station (e.g., gNB) 20 for transmission adjustment in a communication network system 30 (e.g., non-terrestrial network (NTN) or terrestrial network) according to an embodiment of the present disclosure are provided. The communication network system 30 includes the one or more UEs 10 and the base station 20. The one or more UEs 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the communication between the UE 10 and the BS 20 comprises non-terrestrial network (NTN) communication. In some embodiments, the base station 20 comprises spaceborne platform or airborne platform or high altitude platform station. The base station 20 can communicate with the UE 10 via a spaceborne platform or airborne platform, e.g. NTN satellite 40, as illustrated in FIG. 1B.

Spaceborne platform includes satellite and the satellite includes low earth orbiting (LEO) satellite, medium earth orbiting (MEO) satellite and geostationary earth orbiting (GEO) satellite. While the satellite is moving, the LEO and MEO satellite is moving with regard to a given location on earth. However, for GEO satellite, the GEO satellite is relatively static with regard to a given location on earth.

In some embodiments, the processor 11 is configured to be configured, by the base station 20, with a first frequency band and/or a second frequency band for a serving cell and the processor 11 is configured to perform transmission and/or reception in the first frequency band and/or the second frequency band. This can solve issues in the prior art, reduce inter-beam interference, realize frequency division multiplexed (FDM) beams, provide a good communication performance, and/or provide high reliability.

In some embodiments, the processor 21 is configured to configure, to the user equipment (UE) 10, a first frequency band and/or a second frequency band for a serving cell and the processor 21 is configured to perform transmission and/or reception in the first frequency band and/or the second frequency band. This can solve issues in the prior art, reduce inter-beam interference, realize frequency division multiplexed (FDM) beams, provide a good communication performance, and/or provide high reliability.

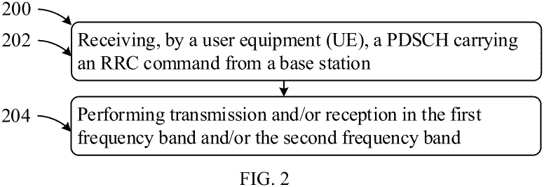

FIG. 2 illustrates a method 200 of wireless communication by a user equipment (UE) according to an embodiment of the present disclosure. In some embodiments, the method 200 includes: a block 202, receiving, by a user equipment (UE), a PDSCH carrying an RRC command from a base station; and a block 204, performing transmission and/or reception in the first frequency band and/or the second frequency band. This can solve issues in the prior art, reduce inter-beam interference, realize frequency division multiplexed (FDM) beams, provide a good communication performance, and/or provide high reliability.

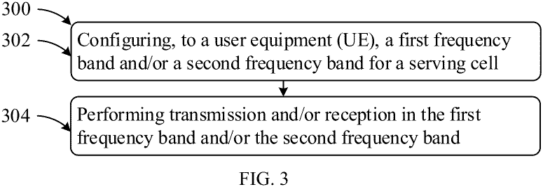

FIG. 3 illustrates a method 300 of wireless communication by a base station according to an embodiment of the present disclosure. In some embodiments, the method 300 includes: a block 302, configuring, to a user equipment (UE), a first frequency band and/or a second frequency band for a serving cell; and a block 304, performing transmission and/or reception in the first frequency band and/or the second frequency band. This can solve issues in the prior art, reduce inter-beam interference, realize frequency division multiplexed (FDM) beams, provide a good communication performance, and/or provide high reliability.

In some embodiments, the first frequency band and/or the second frequency band are within a carrier bandwidth of the serving cell. In some embodiments, the first frequency band and the second frequency band are separated in frequency domain. In some embodiments, the first frequency band comprises a first center frequency, and the second frequency band comprises a second center frequency. In some embodiments, the first center frequency and/or the second center frequency are signaled by the base station to the UE. In some embodiments, the first frequency band is not overlapped with the second frequency band. In some embodiments, a location of the first frequency band comprises a starting location of the first frequency band and a bandwidth of the first frequency band. In some embodiments, the starting location of the first frequency band is determined by a first offset. In some embodiments, the bandwidth of the first frequency band is determined by a first bandwidth length. In some embodiments, the starting location comprises a starting resource block (RB) or common RB (CRB). In some embodiments, a location of the second frequency band comprises the starting location of the second frequency band and the bandwidth of the second frequency band. In some embodiments, the starting location of the second frequency band is determined by a second offset. In some embodiments, the bandwidth of the second frequency band is determined by a second bandwidth length. In some embodiments, the location of the second frequency band is determined by a second offset and/or a second bandwidth length. In some embodiments, the first offset and/or the first bandwidth length and/or the second offset and/or the second bandwidth length comprises a unit of RB or CRB. In some embodiments, the location of the first frequency band and/or the second frequency band are determined by a guard band. In some embodiments, the guard band separates the first frequency band and the second frequency band in the carrier bandwidth. In some embodiments, the guard band is determined by a third offset and/or a guard band length, wherein the third offset and/or the guard band length comprise a unit of resource block (RB) or common RB (CRB). In some embodiments, the guard band length comprises a value of zero; or the guard band length is pre-defined. In some embodiments, the first frequency band comprises a first carrier bandwidth and/or the second frequency band comprises a second carrier bandwidth.

In some embodiments, the first carrier bandwidth starts from a first reference point by a fourth offset. In some embodiments, the second carrier bandwidth starts from the first reference point or a second reference point by a fifth offset. In some embodiments, the first carrier bandwidth comprises a third bandwidth length and/or the second carrier bandwidth comprises a fourth bandwidth length. In some embodiments, the fourth offset and/or the fifth offset and/or the third bandwidth length and/or the fourth bandwidth length comprise a unit of RB or CRB. In some embodiments, the UE is further configured with a first bandwidth part (BWP), wherein the first BWP comprises a first BWP id. In some embodiments, the first BWP id is configured to be associated with the first frequency band and/or the second frequency band. In some embodiments, a location of the first BWP is determined in an associated frequency band, wherein the associated frequency band comprises the first frequency band and/or the second frequency band. In some embodiments, the location of the first BWP comprises a starting location of the first BWP and/or a BWP length. In some embodiments, the starting location comprises a starting RB or CRB. In some embodiments, the starting location of the BWP is determined by a sixth offset and/or a BWP length, wherein the sixth offset comprises a number of RB or CRB between the starting location of the associated frequency band and the starting location of the first BWP. In some embodiments, the first BWP is confined in its associated frequency band. In some embodiments, when the location of the first BWP, determined by the sixth offset and/or the BWP length, exceeds the associated frequency band by a number RB or CRB, the first BWP is truncated to be confined in the associated frequency band. In some embodiments, the BWP truncation comprises removing the number of RB or CRB from the first BWP.

In some embodiments, the first BWP comprises an active BWP. In some embodiments, the base station configures the UE to perform transmission or reception in the active BWP in an active frequency band, wherein the active frequency band comprises at least the first frequency band and/or the second frequency band. In some embodiments, activation and/or deactivation of the first frequency band and/or the second frequency band are controlled by the base station using an radio resource control (RRC) signaling, a medium access control (MAC) control element (CE), or a downlink control information (DCI); or the activation and/or deactivation of the first frequency band and/or the second frequency band are determined according to an active beam, a physical downlink control channel (PDCCH) transmission configuration indicator (TCI) state, a physical downlink shared channel (PDSCH) TCI state, or a control resource set (CORESET) TCI state. In some embodiments, the first frequency band comprises a first band id and/or the second frequency band comprises a second band id. In some embodiments, the first frequency band id and/or the second frequency band id are associated with one or more beam ids. In some embodiments, the first frequency band id is associated with a first beam id, and/or the second frequency band id is associated with a second beam id. In some embodiments, the first center frequency is associated with the first bean id, and/or the second center frequency is associated with the second beam id. In some embodiments, the first beam id comprises a first downlink signal id, and/or the second beam id comprises a second downlink signal id. In some embodiments, the first and/or the second downlink signal comprises at least a downlink synchronization signal and/or a downlink reference signal. In some embodiments, the downlink signal id comprises at least an SSB index and/or CSI-RS resource index and/or CSI-RS resource set index.

In some embodiments, the one or more beam ids comprise at least one of the followings: synchronization signal block (SSB) indexes, or channel state information reference signals (CSI-RS) resource indexes or CSI-RS resource set indexes. In some embodiments, the first frequency band comprises a first set of SSBs and/or the second frequency band comprises a second set of SSBs. In some embodiments, the first set of SSBs location corresponds to a first synchronization signal (SS) raster and/or the second set of SSBs location corresponds to a second synchronization signal (SS) raster. In some embodiments, an interval between the first and the second SS rasters is pre-defined or signaled by the base station. In some embodiments, an SSB in an SSB index transmitted by the base station to the UE is corresponding to an SSB index and/or a carrier bandwidth index and/or a beam index association relationship. In some embodiments, the UE assumes that other SSB indexes are invalid SSB indexes, in which there is no SSB transmission. In some embodiments, when the UE receives a downlink transmission in resource blocks that are overlapped in time and frequency domain with resources corresponding to the invalid SSB indexes, the UE does not need to perform rate-matching.

In some embodiments, when the UE receives a downlink transmission in resource blocks that are overlapped in time and frequency domain with resources corresponding to the valid SSB indexes, the UE needs to perform rate-matching. In some embodiments, for a set of SSB indexes at a same SS raster, a quasi-co-location (QCL) relationship among the SSB indexes is indicated by the base station to indicate whether a ith SSB index and a jth SSB index are QCL’ed or not. In some embodiments, if the ith SSB index and the jth SSB index are QCL’ed, the ith SSB index and the jth SSB index are transmitted by a same beam. In some embodiments, if the ith SSB index and the jth SSB index are QCL’ed, the the ith SSB index and the jth SSB index share the same validity. In some embodiments, when mod(SSB index #i, Q) is a same value as mod(SSB index #j, Q), then the ith SSB index and the jth SSB index are QCL’ed, where Q is an integer and mod is a modulo operation. In some embodiments, the Q value is separately configured for each carrier bandwidth index or a same value is configured for all carrier bandwidth indexes. In some embodiments, association between an SSB index and a carrier bandwidth index or a subband index is pre-defined. In some embodiments, the associated SSB index with the carrier bandwidth is the valid SSB index in the carrier bandwidth. In some embodiments, an SSB index is not associated with the carrier bandwidth, and the SSB index not associated with the carrier bandwidth is a valid SSB index depending on the Q value.

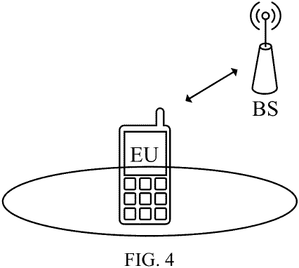

FIG. 4 illustrates a communication system including a base station (BS) and a UE according to another embodiment of the present disclosure. Optionally, the communication system may include more than one base station, and each of the base stations may connect to one or more UEs. In this disclosure, there is no limit. As an example, the base station illustrated in FIG. 1A may be a moving base station, e.g. spaceborne vehicle (satellite) or airborne vehicle (drone). The UE can transmit transmissions to the base station and the UE can also receive the transmission from the base station. Optionally, not shown in FIG. 4, the moving base station can also serve as a relay which relays the received transmission from the UE to a ground base station or vice versa.

Spaceborne platform includes satellite and the satellite includes LEO satellite, MEO satellite and GEO satellite. While the satellite is moving, the LEO and MEO satellite is moving with regards to a given location on earth. However, for GEO satellite, the GEO satellite is relatively static with regards to a given location on earth. A moving base station or satellite, e.g. in particular for LEO satellite or drone, communicates with a user equipment (UE) on the ground. Due to long distance between the UE and the base station on satellite, the beamformed transmission is needed to extend the coverage.

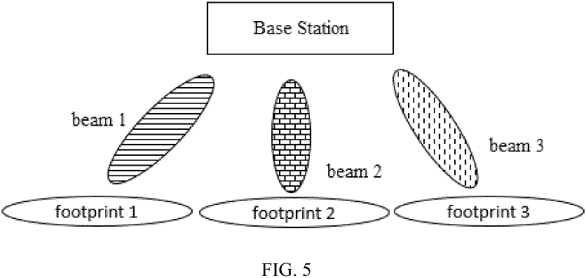

Optionally, as illustrated in FIG. 5, where a base station is integrated in a satellite or a drone, and the base station transmits one or more beams to the ground forming one or more coverage areas called footprint. In FIG. 5, an example illustrates that the BS transmits three beams (beam 1, beam 2 and beam3) to form three footprints (footprint 1, 2 and 3), respectively. Optionally, 3 beams are transmitted at 3 different frequencies. In this example, the bit position is associated with a beam. FIG. 5 illustrates that, in some embodiments, a moving base station, e.g. in particular for LEO satellite or drone, communicates with a user equipment (UE) on the ground. Due to long distance between the UE and the base station on satellite, the beamformed transmission is needed to extend the coverage. As illustrated in FIG. 5, where a base station is transmitting three beams to the earth forming three coverage areas called footpoints. Moreover, each beam may be transmitted at dedicated frequencies so that the beams for footprint 1, 2 and 3 are non-overlapped in a frequency domain. The advantage of having different frequencies corresponding to different beams is that the inter-beam interference can be minimized.

Some embodiments of the present disclosure present some methods for realizing FDM beams. In some embodiments, some methods are to group the configured bandwidth part (BWP) into groups, the BWP may be for example, DL BWP and/or UL BWP. In a legacy terrestrial system, under a given serving cell, a network such as gNB may configure one or more BWPs, and the BWPs are grouped together under the serving cell. In some embodiments, under a given serving cell, one or more BWP groups are defined, and these BWP groups are associated with the serving cell. In details, the one or more BWP groups may be directly associated with the serving cell; or the one or more BWP groups may be associated with a first parameter, and the first parameter is further associated with the serving cell.

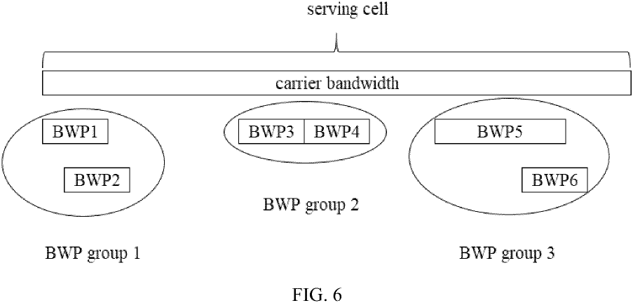

In some examples, for a given serving cell, the network configures one or more BWPs, and these BWPs are configured into one or more BWP groups. Here a BWP group may mean that one or more BWP are associated together as illustrated in FIG. 6. FIG. 6 illustrates that, in some embodiments, under the serving cell, the network configures three BWP groups, and for each BWP group, there are two configured BWPs as an example. These three BWP groups are within the serving cell and the carrier bandwidth. Optionally, in each BWP group, the BWPs may be overlapped or non-overlapped in frequency domain. The BWPs in different BWP groups, are non-overlapped in frequency domain.

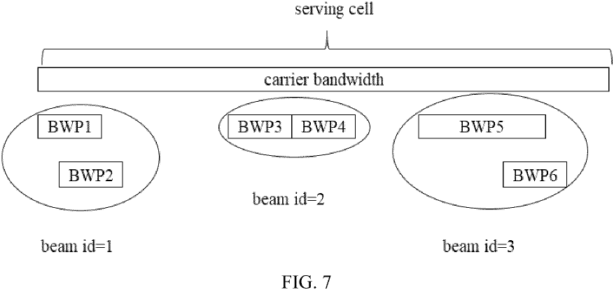

In order to configure the BWP group association with the configured BWPs, some embodiments may introduce an RRC parameter and this RRC parameter is associated with one or more BWPs to form a BWP group. The RRC parameter may be an RRC information element (IE), an example of this RRC parameter may be satellite beam related parameter, in an example, it is called as satellite beam configuration, e.g. SatBeamConfig. In this IE, the network may configure satellite beam identity (SatBeam_id) and the associated BWPs. One example of such association is presented in the following: in the SatBeamConfig IE, it configures SatBeam_id, and for a given SatBeam _id, the network may further configure one or more downlink BWPs by configuring downlinkBWP-ToAddModList and/or downlinkBWP-ToReleaseList. The downlink BWPs that are configured under a given SatBeam_id are in the same BWP group. Optionally, the network may further configure uplink configuration in the SatBeamConfig IE. In case the uplink configuration is configured in the SatBeamConfig IE, the one or more uplink BWPs configured in the uplink configuration may be associated with the SatBeam_id too. This method can realize the BWP grouping corresponding to a satellite beam id as illustrated in FIG. 7. It is to note that the SatBeamConfig IE is only an example, this method can be similarly applied to other naming of the IE, e.g. BWPgroupConfig IE instead of SatBeamConfig IE, where instead of SatBeam_id, the network may use a BWPgroup_id; or subbandConfig IE, where instead of SatBeam_id, the network may use a subband_id.

Example of the RRC IE is satellite beam configuration
SatBeamConfig { SatBeam_id, and/or downlinkBWP-ToReleaseList and/or downlinkBWP-
ToAddModList and/or uplinkConfig }

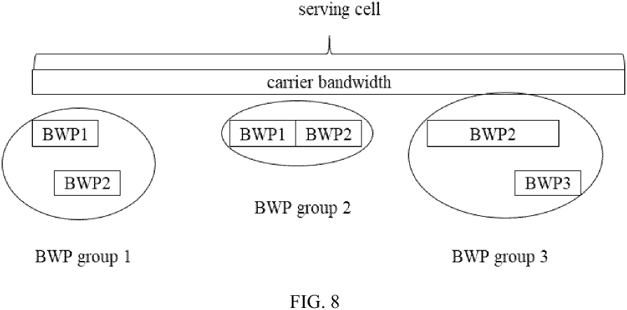

From an example of FIG. 6 and FIG. 7, it can be observed that when the number of the satellite beams gets higher, more BWPs are to be configured to cover all the satellite beams. If the number of the configured BWP is limited to a small value, e.g. 4, with the above method, the maximum supported beams or the maximum number of the BWP groups is 4, which might limit the NTN system efficiency. To address this issue, some embodiments present the following solution: for different BWP groups, they may contain a same BWP id. As illustrated in FIG. 8, a given BWP id (for instance BWP 1) is not exclusive to a given BWP group.

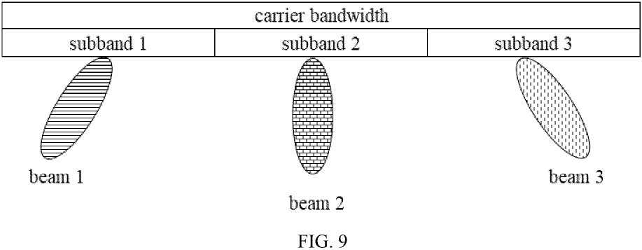

The next question is that how to configure a BWP with a given BWP id in different frequency locations in different BWP groups as illustrated in FIG. 8. In the following, some embodiments present a configuration method. The network can first configure one or more subbands in the carrier bandwidth of a given serving cell as illustrated in FIG. 9. Optionally, each subband may be used to represent a satellite beam. Thus, more subbands are configured, it may represent more satellite beams. Note that the subbands may be fully separated in frequency domain, i.e. non-overlapped, or partially overlapped.

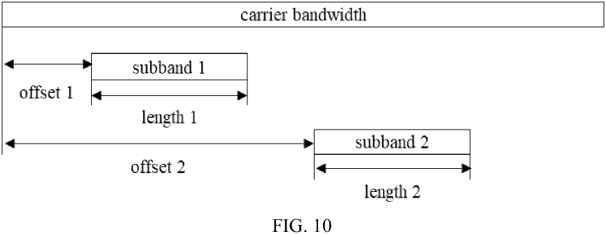

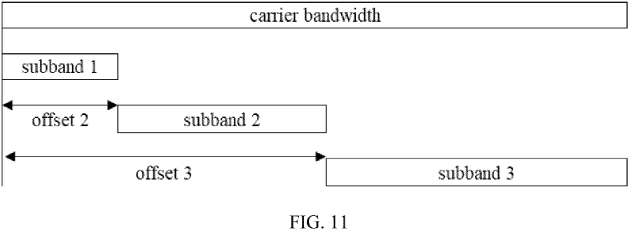

FIG. 10 illustrates that, in some embodiments, the configuration of the subbands can follow two different options. In a first option, the subband is configured with a location and a bandwidth, where the location is used to determine a reference position, e.g. a starting location of a subband or a center frequency location of a subband; the bandwidth is used to determine the subband bandwidth, which may be in unit of resource block (RB) of common RB. Note that 1 RB contains 12 subcarriers in frequency domain and each subcarrier has a dedicated bandwidth called subcarrier spacing (SCS). The possible SCS values are 15*2^{^u} KHz, where u=0, 1, 2, 3.... The starting location may be a starting RB of a subband. The center frequency location may be a location of the center subband. Optionally, the subband location may be indicated by an offset and the subband bandwidth may be indicated by a subband length. For example, the offset is used to determine the subband starting location with respect to the carrier bandwidth RB boundary. The offset may be in a unit of RB or common RB. Thus, multiple subbands can be configured with multiple offset values and/or subband length values. In some examples, the offset of the subband is not needed to be configured, as some embodiments may assume that the first subband starts from the starting RB of the carrier bandwidth, as illustrated in FIG. 11. Optionally, the subband length may be pre-defined, or multiple subbands may share a same subband bandwidth.

Using offset and length parameters to configure subband might need large overhead signaling issue. To further reduce the overhead, another option is to only configure the offset and subband length may be implicitly determined. More specifically, for the subband#n, its bandwidth may be assumed to be 1 RB before the starting RB of the subband#(n+1) as illustrated in FIG. 11. In this configuration method, the network needs to indicate the number of the subbands, e.g. three subbands in FIG. 11, and the starting RB of each of the subbands, thus the bandwidth may be implicitly determined by the following rules: 1) the first subband starting RB is the starting RB of the carrier bandwidth; 2) the last subband ends at the last RB of the carrier bandwidth; 3) for the subband#n, its bandwidth starts from the starting RB and ends at the last RB before the starting RB of the subband#(n+1). Optionally, the location of the subband is determined by a center frequency, which is signaled by the network.

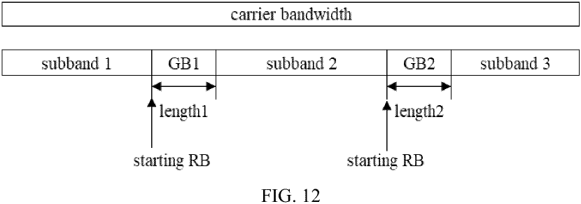

In some examples, the network may need to configure some guard band between two subbands, so that the inter-subband interference or inter-beam interference can be further minimized. In this case, the network may directly configure the location and the length of the guard band and the subbands can be derived from the guard bands. In FIG. 12, the network indicates two guard bands (GB) and their corresponding starting RB and GB length. The UE assumes that the first subband (subband 1) starts from the starting RB of the carrier bandwidth and the last subband (subband 3) ends at the last RB of the carrier bandwidth. Moreover, the subband 1 ends at the last RB before the starting RB of the guard band 1. The subband 2 starts at the first RB after the guard band 1 and ends at the last RB before the starting RB of the guard band 2. The subband 3 starts at the first RB after the guard band 2 and ends at the last RB of the carrier bandwidth. It is note that the guard band length may be configured as zero or non-zero.

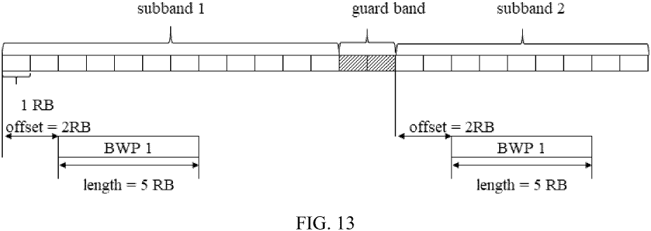

After subbands are configured in the carrier bandwidth, the BWP position is determined based on subband position. As previously presented, in some methods, one or more BWPs can be configured to associate with a given subband. Moreover, the BWP configuration indicates a BWP starting RB and a BWP length. In legacy system, these two parameters are jointly encoded by ‘locationAndBandwidth’ under BWP configuration IE, and in legacy system, the BWP starting RB is indicated by an offset from the starting RB of the carrier bandwidth. In some methods, some embodiments set that the BWP starting RB is signaled with respect to a subband that the BWP is associated with. For example, the configured offset for determining the BWP starting RB should be calculated from the starting RB of the associated subband. An example is illustrated in FIG. 13, where the network configures a BWP1, with BWP ID=1, to associate with both subband 1 and subband 2. The BWP configuration for BWP 1 is similar to legacy system, i.e. configuring an offset value for the BWP starting RB and a BWP length value for the BWP bandwidth. In some examples, some methods assume that the offset is 2 RB and the length is 5 RB. Thus, the BWP 1 position can be determined in the corresponding subband1 and subband 2 as in FIG. 13. The starting RB is determined according to the configured offset and the corresponding subband starting RB, i.e. for BWP 1 in subband 1, the BWP 1 starting RB is located 2 RB offset from the starting RB of the subband1 and the BWP 1 in subband2, the BWP 1 starting RB is located 2 RB offset from the starting RB of the subband2.

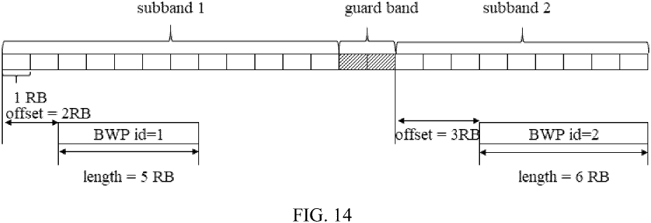

When the network configures a value for the BWP which is associated with a subband, the configured value may be selected such that the BWP is confined within the subband. As illustrated in FIG. 14, BWP 1 is configured to be associated with subband 1 and BWP 2 is configured to be associated with subband 2. Thus, the BWP1 is configured to be confined in subband 1 and BWP2 is configured to be confined in subband 2.

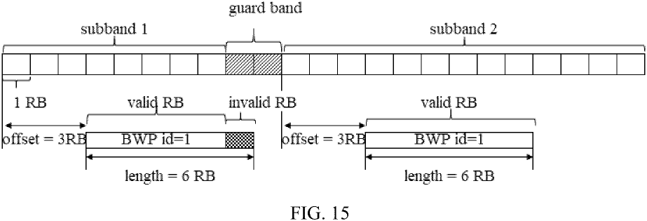

When a BWP with a given ID is configured to be associated with more than one subbands (as illustrated in FIG. 13, same BWP id=1 is configured to be associated with both subband 1 and subband 2), the UE may expect that the value of the BWP length as well as the offset value are selected by the network such that the BWP is confined in any associated subband. Optionally, if the configured BWP exceeds the bandwidth of the corresponding subband, the UE may ignore the exceeded part and only assumes that the RBs of the BWP that are within the corresponding subband are the valid RBs for the BWP, as illustrated in FIG. 15, where the same BWP id=1 is associated with both subband 1 and subband 2. The offset for BWP id=1 is configured to be 3 RB and the BWP length is 6 RB. It turns out that in subband 1, the BWP exceeds the subband1. Then, the UE will ignore the exceeded RB and determines the BWP id=1 in subband 1 has 5 valid RB length. While the BWP id=1 in subband2 still has 6 valid RBs length as the BWP are fully confined in the subband 2.

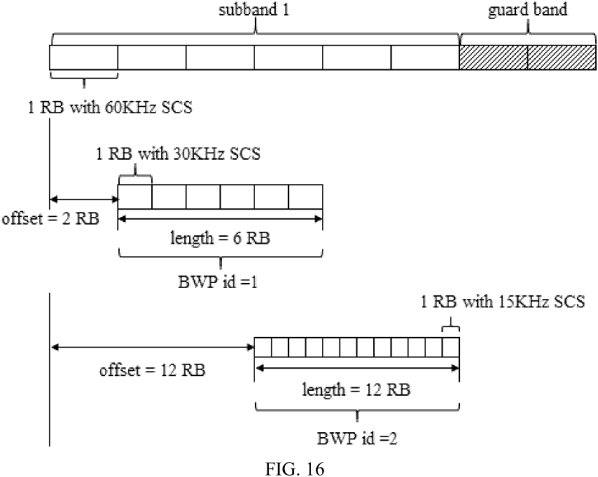

In some examples, the network configures more than one subbands for a serving cell according to a reference subcarrier spacing (SCS). For instance, when operating in frequency range 1, e.g. below 7 GHz, the reference SCS is 60 KHz, and the subbands and/or the guard bands are configured according to 60 KHz SCS. When the network configures one or more BWP to be associated with a subband, the BWP location and length are determined according to the BWP dedicated SCS as illustrated in FIG. 16, where the subband 1 and guard band are configured based on SCS 60 KHz (reference SCS), while its associated BWP1 and BWP 2 are determined according to their own SCS (e.g. for BWP1, the SCS is 30 KHz, and for BWP 2 the SCS is 15 KHz). Optionally, the offset values and/or BWP length configured for the BWP may be selected such that the BWP is RB-boundary aligned with the corresponding subband. For instance, for BWP id=1 with SCS 30 KHz, the offset value and/or the BWP length may be an even integer so that the BWP id=1 can be RB boundary aligned with the subband 1. Similarly, for BWP id=2 with SCS 15 KHz, the offset value and/or the BWP length may be selected by an integer multiple of 4, so that the BWP id=2 can be RB aligned with the subband 1. The advantage of RB boundary alignment with the subband is that the offset and length signaling overhead can be greatly reduced, e.g. for BWP id=1, only even number is signaled. It is to note that the reference SCS may be pre-defined, or RRC configured, or the reference SCS may be the same as the SCS of the carrier bandwidth, or the reference SCS may be the same as the SCS of one of the BWP that is associated with a given subband.

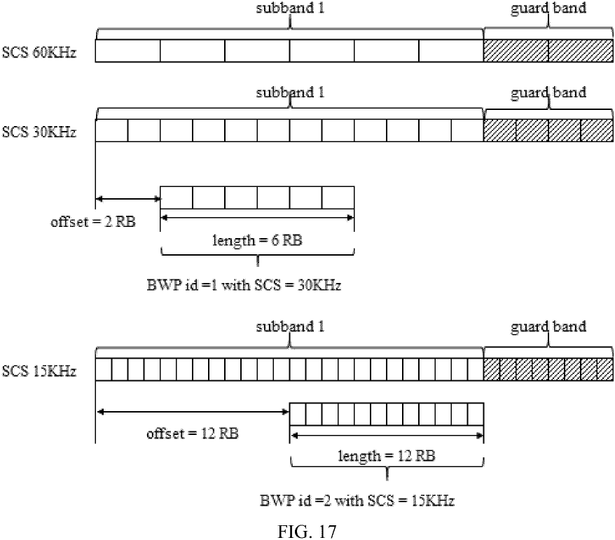

In some examples, the network may configure one or more subbands and/or one or more guard bands according to different SCS, e.g. the network provides the configurations for one or more subbands and/or one or more guard bands according to SCS 15 KHz, 30 KHz and 60 KHz, respectively. As presented in FIG. 17, where the network provides three subband configurations, each corresponding to a dedicated SCS, e.g. in FIG. 17, the network provides the subband configuration for SCS 60 KHz, 30 KHz and 15 KHz, respectively. Then the UE may determine the BWP using the BWP configuration (e.g. offset and length) and the subband of the same SCS as the BWP, for determining BWP with 30 KHz, the UE uses 30 KHz subband. The advantage of this method is that the BWP is already RB-boundary aligned with its associated subband since they have the same SCS. Optionally, the network needs to ensure that the subband and/or the guard band, configured from 60 KHz SCS, 30 KHz SCS and 15 KHz SCS are aligned, i.e. subbands and/or guard band are fully overlapped as illustrated in FIG. 17. It is to note that the guard band can be zero, leading to no guard band case.

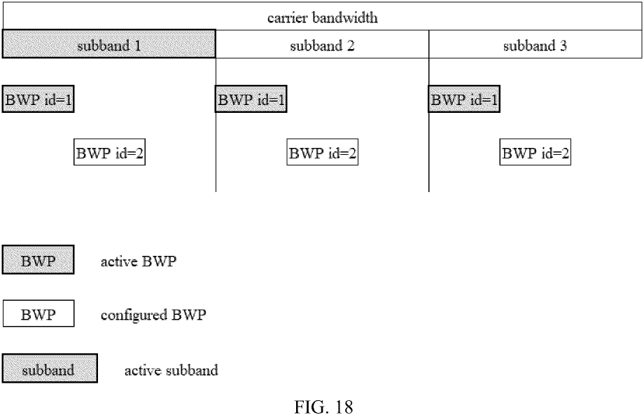

In some examples, the network may configure one active BWP and/or one default BWP per subband. Moreover, there is an active subband among multiple configured subbands. Only the active BWP in the active subband is activated. While the active BWP in an inactive subband is not activated. As illustrated in FIG. 18, the network configures three subbands, and two BWPs (BWP id=1 and BWP id=2), in which BWP id=1 is configured to be an active BWP. The BWP id=1 and BWP id=2 are associated with subband 1, 2 and 3. When the subband 1 is an active subband, the UE operates in the subband 1 and the active BWP is the BWP id=1 in the subband 1. If the active subband is switched to subband 2, the UE may operate in the active BWP (BWP id=1) in the subband 2. Moreover, in a given subband, the network may change the active BWP from BWP id=1 to BWP id=2 by DCI and/or RRC reconfiguration. It is to note that when the subband is replaced with BWP group, the same principle may be applied here, e.g. the network may signal an active BWP group, then the active BWP of the active BWP group is activated. Thus, similar mechanism is not repeated in this disclosure, in general, subband id and beam id and BWP group id may be inter-changed and may be similarly applicable in our presented method.

In some examples, the activation/deactivation of a subband may be controlled by the network. For instance, the network may use RRC signaling and/or MAC-CE and/or DCI to activate or deactivate a subband. For RRC signaling, the network may use a directly set a subband id to be the active subband. For MAC-CE, the network may use bit-mapping to activate a subband, e.g. if the network configures three subbands as in FIG. 18, the network uses 3 bits, with each bit mapping to a subband. Then if the value of the bit is ‘1’, it refers to activated. If the value of the bit is ‘0’, it refers to deactivated. It is to note that in the MAC-CE format, it may also include serving cell ID in order to signal that the subband ID belongs to which serving cell. For DCI indication, the DCI may contain an indication field of X bits, where X = [log₂(M)], and M is the number of the configured subbands; [a] represents the smallest integer than is larger than a. The network may use Xbits indicate an active subband.

In some examples, the subbands are associated with satellite beams, e.g. each subband corresponds to a satellite beam. In this case, the active subband may be determined by the active satellite beam. Optionally, the satellite beams may be associated with downlink reference signals, e.g. SSB and/or CSI-RS. Thus, different satellite beams may be differentiated by different SSB index and/or different CSI-RS resource index. The active satellite beam may be determined by the UE, e.g. there is a one-to-one mapping between the configured subband index and downlink reference signal index (SSB index or CSI-RS resource index). When the UE determines an SSB index with the best received energy, the UE determine that the active subband is the subband index corresponding to the SSB index. It is note that SSB index is also known as candidate SSB index, in this disclosure, these two terms are inter-changeable.

In some examples, the active subband may be determined by other parameters, e.g. PDCCH transmission configuration indicator (TCI) state, or PDSCH TCI state, or CORESET TCI state. More specifically, there is a one-to-one mapping between the configured subband index and downlink reference signal index (SSB index or CSI-RS resource index). The network may indicate a TCI state for CORESET#0, the TCI state indicates a downlink reference signal index. When the network indicates a TCI state for CORESET#0 is a first SSB index, the active subband is the subband index corresponding to the SSB index.

In some examples, when the network configures a TCI state for PDSCH or PDSCH or PUSCH or PUCCH, the TCI state includes a QCL-Info IE. By introducing the subbands, the QCL-Info IE may include a subband index together with a BWP index for indicating a CSI-RS resource index and/or SSB index. It indicates the CSI-RS resource is in the indicated BWP (with BWP id) in the indicated subband (with subband id).

QCL-Info ::= SEQUENCE {
cell ServCellIndex OPTIONAL, -- Need R
subband-Id
bwp-Id BWP-Id OPTIONAL, -- Cond CSI-RS-Indicated
referenceSignal CHOICE {
csi-rs NZP-CSI-RS-ResourceId,
ssb SSB-Index
},
qcl-Type ENUMERATED {typeA, typeB, typeC, typeD},
...
}

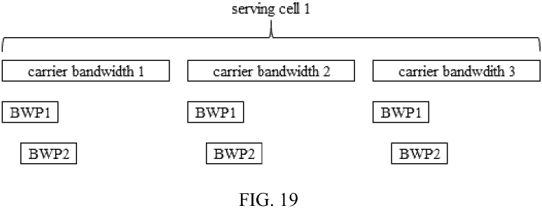

FIG. 19 illustrates that, in some examples, more than one carrier bandwidth may be configured for a given serving cell. In this example a carrier bandwidth is equivalent to a subband as in previous examples. The one or more configured BWPs in a carrier bandwidth are grouped in a BWP group. Optionally, the carrier bandwidth may be given an index for a serving cell.

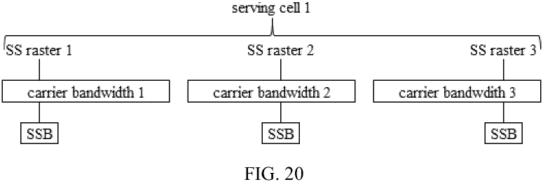

In some examples, different carrier bandwidth of a given serving cell may be used to transmit signals with a given beam direction. In a carrier bandwidth there may be an SSB transmission and the SSB center located in a synchronization raster entry as defined in TS 38.101-1 (we call it SS raster in this disclosure). In FIG. 20, SSB is transmitted one or more carrier bands of the serving cell at different SS rasters.

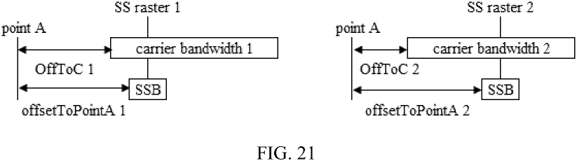

In some examples, each carrier bandwidth is located relative to a reference point (called point A). Thus, as shown in FIG. 21 that for different carrier bandwidth of the same serving cell, there may be different point A, each served as a preference point for resource block grids for the corresponding carrier bandwitdth. Note that Point A serves as a common reference point for resource block grids and is obtained from the followings:

offsetToPointA for a PCell downlink where offsetToPointA represents the frequency offset between point A and the lowest subcarrier of the lowest resource block, which has the subcarrier spacing provided by the higher-layer parameter subCarrierSpacingCommon and overlaps with the SS/PBCH block (SSB) used by the UE for initial cell selection, expressed in units of resource blocks assuming 15 kHz subcarrier spacing for FR1 and 60 kHz subcarrier spacing for FR2.

absoluteFrequencyPointA for all other cases where absoluteFrequencyPointA represents the frequency-location of point A expressed as in ARFCN.

Optionally, the network may indicate a number of the carrier bandwidth of the same serving cell and/or the SS raster frequencies corresponding to the SSBs in the respective carrier bandwidth, and/or the Point A frequencies of the corresponding carrier bandwidths, and/or one or more offset values between each carrier bandwidth and its reference point A (OffToC values in FIG. 21), and/or one or more offset values of offsetToPointA corresponding to different SSB in respective carrier bandwidth and/or the bandwidth size of the respective carrier bandwidth. When a UE obtains these parameters, the UE may determine the positions of point A and/or SSB and/or carrier bandwidth. Optionally, the indication may be in system information, e.g. MIB or SIB. Optionally, the indication may be in UE-specific RRC signaling.

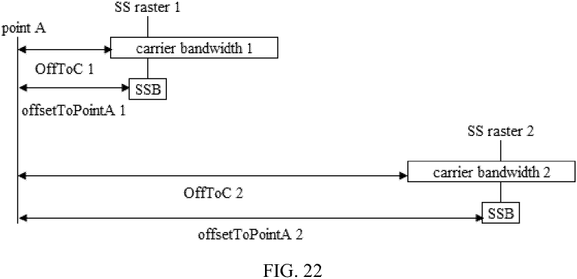

In some examples in FIG. 22, a same reference point A is used for multiple carrier bandwidths of a given serving cell.In some examples, when the network configures a TCI state for PDSCH or PDSCH or PUSCH or PUCCH, the TCI state includes a QCL-Info IE. By introducing the subbands, the QCL-Info IE may include a carrier bandwidth index together with a BWP index for indicating a CSI-RS resource index and/or SSB index. It indicates the CSI-RS resource is in the indicated BWP (with BWP id) in the indicated carrier bandwidth (with carrier bandwidth id).

QCL-Info ::= SEQUENCE {
cell ServCellIndex OPTIONAL, -- Need R
carrier bandwidth-Id
bwp-Id BWP-Id OPTIONAL, -- Cond CSI-RS-Indicated
referenceSignal CHOICE {
csi-rs NZP-CSI-RS-ResourceId,
ssb SSB-Index
},
qcl-Type ENUMERATED {typeA, typeB, typeC, typeD},
...
}

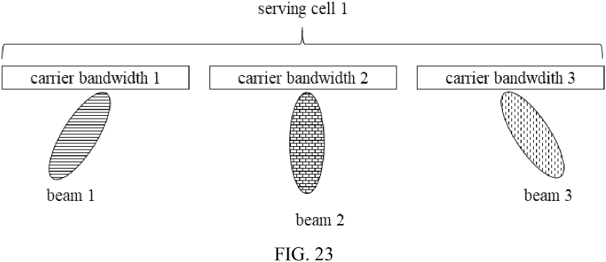

In some examples, each carrier bandwidth is assigned with a dedicated satellite beam. Thus, the transmissions in different carrier bandwidth represent different satellite beams as shown in FIG. 23.

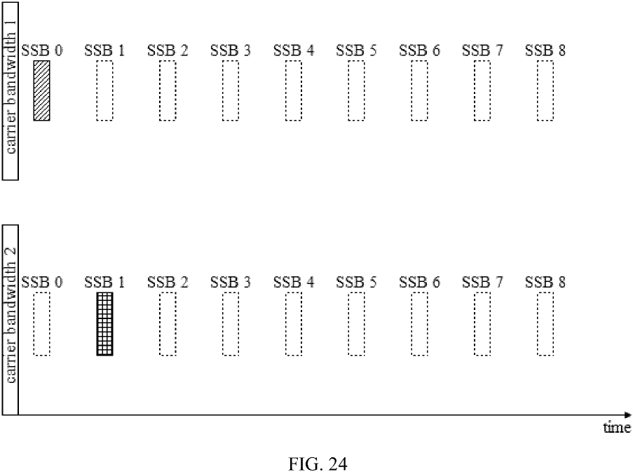

In some examples, the SSBs transmitted in a carrier bandwidth may also follow a dedicated satellite beam. Moreover, the SSBs transmitted in a carrier bandwidth may follow a predefined time domain symbol positions within a half-frame and each SSB has an SSB index according to section 4.1 of TS 38.213. Thus, a dedicated SSB index may be associated with a dedicated satellite beam, as illustrated in FIG. 24, where assume that the carrier bandwidth 1 is associated with satellite beam 1 and the satellite beam 1 is further associated with SSB index 0. At the same time, the carrier bandwidth 2 is associated with satellite beam 2, and SSB index 1 is associated with satellite beam 2. Thus, the network may only transmit an SSB in a SSB index corresponding to the SSB index and/or carrier bandwidth index and/or satellite beam index association relationship. It means that in carrier bandwidth 1, the SSB is transmitted in the SSB index 0; while in carrier bandwidth 2, the SSB is transmitted in SSB index 1. Otherwise said, a UE may determine the SSB index 0 is a valid SSB index, in which the SSB is transmitted by the network, for the carrier bandwidth 1. Similarly, the UE may determine the SSB index 1 is a valid SSB index, in which the SSB is transmitted by the network, for the carrier bandwidth 2. Optionally, the UE may assume that other SSB indexes are invalid SSB indexes, in which there is not SSB transmissions. Thus, when the UE receives a downlink transmission, e.g. CSI-RS or PDCCH or PDSCH, in the resource blocks that are overlapped in time and frequency domain with the resources corresponding to the invalid SSB indexes, the UE does not need to perform rate-matching to avoid the collision with SSB transmission according to section 5.1.4 of TS 38.214. Optionally, the UE needs to perform rate-matching around the resources, corresponding to valid SSB index, according to section 5.1.4 of TS 38.214. Optionally, the carrier bandwidth index and/or SSB index and/or satellite beam index association relationship may be signaled by the network in a system information, e.g. MIB or SIB, or in a UE-specific RRC signaling.

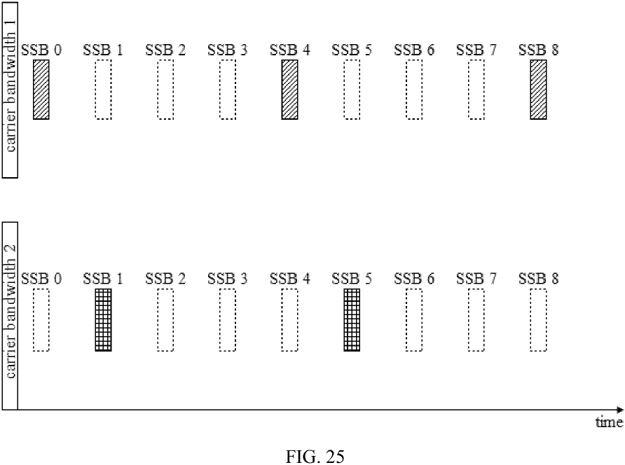

In some examples, for a set of SSB indexes at a same SS raster, the network may indicate a QCL relationship among the SSB indexes to indicate whether SSB index #i and SSB index #j are QCL’ed or not. If they are QCL’ed, it means that they are transmitted by a same beam. In this case, these two SSB indexes share the same validity, e.g. if SSB index #i is a valid SSB index, then SSB index #j is also a valid SSB index. The relationship may be following: when mod(SSB index #i, Q) is a same value as mod(SSB index #j, Q), then these two SSB indexes are QCL’ed, where Q is an integer and mod(.) is a modulo operation. Thus, as shown in FIG. 25, where we assume Q=4, then we have SSB 0, 4, 8 are QCL’ed and they are valid SSB indexes in the carrier bandwidth 1; while we have SSB 1, 5 are QCL’ed and they are valid SSB indexes in the carrier bandwidth 2. Optionally, the Q value may be separately configured for each carrier bandwidth index or a same value is configured for all carrier bandwidth indexes. Optionally, the Q value may be a default value. It is important to note that here the carrier bandwidth may be replaced with subband as previously presented and the method may be applied accordingly. In some examples, the association between SSB index and carrier bandwidth index (or subband index) may be pre-defined, e.g. one to one association according to the ordering of the carrier bandwidth index and the SSB index. For instance, assuming we have carrier bandwidth index 0, 1, 2, 3 and all these carrier bandwidths contain SSBs and the SSB index ranging from 0 to 7. Thus, the association may be SSB 0 is associated with carrier bandwidth 0 (SSB 0, CB 0), and following this rule we have (SSB 1, CB1), (SSB 2, CB 2), (SSB 3, CB 3). Optionally, once all the carrier bandwidth is associated, if there are still SSB index left, we may continue the association from the smallest carrier bandwidth index, e.g. (SSB 4, CB 0) and so on. Optionally, the associated SSB index with a given carrier bandwidth is the valid SSB index in the carrier bandwidth. Optionally, when an SSB index is not associated with the carrier bandwidth, it may still be a valid SSB index depending on the Q value as presented previously in some embodiments.

Commercial interests for some embodiments are as follows. 1. Solving issues in the prior art. 2. Reducing inter-beam interference. 3. realizing frequency division multiplexed (FDM) beams. 4. Providing a good communication performance. 5. Providing a high reliability. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

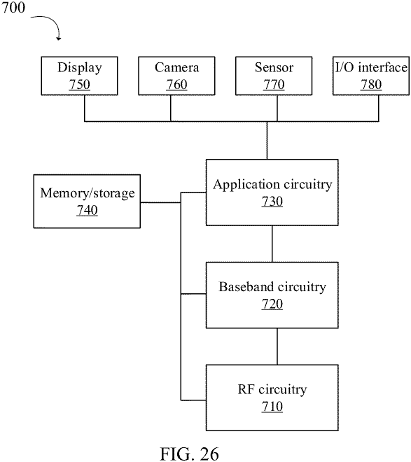

FIG. 26 is a block diagram of an example system 700 for wireless communication according to an embodiment of the present disclosure. Embodiments described herein may be implemented into the system using any suitably configured hardware and/or software. FIG. 26 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multimode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of wireless communication by a user equipment (UE), comprising:
being configured, by a base station, with a first frequency band and/or a second frequency band for a serving cell; and
performing transmission and/or reception in the first frequency band and/or the second frequency band.

2. The method of claim 1, wherein the first frequency band and/or the second frequency band are within a carrier bandwidth of the serving cell.

3. The method of claim 1, wherein the first frequency band and the second frequency band are separated in frequency domain, and the first frequency band comprises a first center frequency, and the second frequency band comprises a second center frequency.

4. The method of claim 3, wherein the first center frequency and/or the second center frequency are signaled by the base station to the UE, and the first frequency band is not overlapped with the second frequency band.

5. The method of claim 1, wherein a location of the first frequency band comprises a starting location of the first frequency band and a bandwidth of the first frequency band.

6. The method claim 5, wherein the starting location of the first frequency band is determined by a first offset, or the starting location of the first frequency band is determined by a first bandwidth length.

7. A method of wireless communication by a base station, comprising:
configuring, to a user equipment (UE), a first frequency band and/or a second frequency band for a serving cell; and
performing transmission and/or reception in the first frequency band and/or the second frequency band.

8. The method of claim 7, wherein the first frequency band and/or the second frequency band are within a carrier bandwidth of the serving cell, and the first frequency band and the second frequency band are separated in frequency domain.

9. The method of claim 7, wherein the first frequency band comprises a first center frequency, and the second frequency band comprises a second center frequency.

10. The method of claim 7, wherein the first frequency band is not overlapped with the second frequency band.

11. The method of claim 7, wherein a location of the second frequency band comprises the starting location of the second frequency band and the bandwidth of the second frequency band.

12. The method claim 11, wherein the starting location of the second frequency band is determined by a second offset, and the bandwidth of the second frequency band is determined by a second bandwidth length.

13. A user equipment (UE), comprising:
a memory;
a transceiver; and
a processor coupled to the memory and the transceiver;
wherein the processor is configured to be configured, by a base station, with a first frequency band and/or a second frequency band for a serving cell; and
wherein the processor is configured to perform transmission and/or reception in the first frequency band and/or the second frequency band.

14. The UE of claim 13, wherein the first frequency band and/or the second frequency band are within a carrier bandwidth of the serving cell.

15. The UE of claim 13, wherein the first frequency band and the second frequency band are separated in frequency domain.

16. The UE of claim 13, wherein the first frequency band comprises a first center frequency, and the second frequency band comprises a second center frequency, and the first center frequency and/or the second center frequency are signaled by the base station to the UE.

17. A base station, comprising:
a memory;
a transceiver; and
a processor coupled to the memory and the transceiver;
wherein the processor is configured to configure, to a user equipment (UE), a first frequency band and/or a second frequency band for a serving cell; and
wherein the processor is configured to perform transmission and/or reception in the first frequency band and/or the second frequency band.

18. The base station of claim 17, wherein the first frequency band and/or the second frequency band are within a carrier bandwidth of the serving cell.

19. The base station of claim 17, wherein the first frequency band and the second frequency band are separated in frequency domain.

20. The base station of claim 17, wherein the first frequency band comprises a first center frequency, and the second frequency band comprises a second center frequency.
